(19) United States
(12) Patent Application Publication
(10) Pub. No.: US 2026/0073183 A1
(43) Pub. Date: Mar. 12, 2026

(54) SYSTEM AND METHOD FOR VALUE CREATION MANAGEMENT

(71) Applicant: 8W8 Advisors Inc., Brooklyn, NY (US)

(72) Inventor: Ralf Hirt, Brooklyn, NY (US)

(21) Appl. No.: 19/323,979

(22) Filed: Sep. 9, 2025

Related U.S. Application Data
(60) Provisional application No. 63/692,934, filed on Sep. 10, 2024.

(51) Int. Cl. G06N 3/04; G06F 18/15; G06F 18/21; G06F 18/2131; G06F 18/2137

(52) U.S. Cl. CPC G06N 3/04; G06F 18/15; G06F 18/2131; G06F 18/2137; G06F 18/2178

(57) ABSTRACT

A computer-implemented system and method for iterative compound value creation management is disclosed. The method includes receiving organizational input data, normalizing and embedding the data, and aggregating the embedded features using a neural model to generate a composite value index. Recommended actions are generated based on the index, and feedback is simulated or collected in response to these actions. The system updates the state of the input data based on feedback and repeats the process for a predetermined number of iterations or until a convergence criterion is satisfied. The invention enables adaptive, data-driven decision-making and continuous improvement in organizational value creation through a modular, scalable software architecture.

### REFERENCE

This application claims the benefit of priority under 35 U.S.C. § 120 of U.S. Provisional Application Ser. No. 63/692,934 filed on Sep. 10, 2024 entitled SYSTEM AND METHOD FOR VALUE CREATION MANAGEMENT, the content of which is relied upon and incorporated herein by reference in its entirety.

### BACKGROUND

In today's rapidly evolving business landscape, measuring, understanding, deploying, and evolving the value drivers of success is paramount. Therefore, the first principle necessitates a focus on one central aspect: value creation.

Companies that develop the right strategies driven by data, and execute those consistently and continuously to completion, delivering more often and faster than their competitors, are winning and realizing their full potential. In short, they are mastering value creation and enjoying the benefits of compounding effects to eventually become unstoppable and extremely valuable. While most every aspect of running an organization is now enabled by technology for data-driven decision making, value creation remains stubbornly analog. While many organizations undertake exercises to define their mission, plans and how they create value, few employ any cohesive structure to ensure value creation ideas are developed, communicated, broken into tasks, assigned, measured, and enhanced on an ongoing basis. As a result, value creation becomes less top of mind, connected to strategy, and impactful on the daily operations of the organization. This scenario reduces organizations' agility, adaptability, ability to compete, and appeal as a vendor, investment target, employer, or partner.

One reason for that lack of structure and rigor is the difficulty of quantifying and tracking value drivers, which can often include softer elements such as the quality of communication or innovation. Without data, organizations struggle to monitor, analyze, and adjust their activities to ensure value creation is on track. By better aligning their actions and decisions with their sources of value creation, thanks to an emerging category of software that seeks to apply data and structure to the task, organizations can rate and assess their own progress using the value creation metrics that are most meaningful for them, benchmarking against themselves as well as comparable companies and sectors.

Adopting a more rigorous, data-driven approach to the value creation process yields better internal alignment, higher-quality decisions, greater agility, perceived brand value to all stakeholders and enhanced talent recruitment and retention. Using value creation software can help management teams, their partners, and their investors elevate their value creation capabilities; positively impact their growth, change, and transformation efforts; and ultimately deliver on their purpose as an organization.

In the competitive business landscape, organizations require effective tools to measure and manage value creation. Existing solutions often fall short in providing comprehensive, real-time insights and lack integration capabilities with diverse data sources. There remains a need for a system that addresses these limitations by offering a robust platform that consolidates data, performs advanced analytics, and delivers actionable insights, which are deployed, implemented and executed to completion in such integrated and holistic system for enhanced value management and value creation.

### SUMMARY OF THE INVENTION

The compound value creation platform is a platform designed to streamline value creation management through a unique combination of data integration, processing, and visualization. The system employs a proprietary assessment algorithm to evaluate beyond common key performance indicators (KPIs) and use augmented metrics across various dimensions of an organization.

The present invention relates to an iterative compound value creation management system and method that leverages modular software architecture and neural network-based analytics to optimize organizational decision-making and performance. The system receives input data comprising organizational attributes, segments, and scores, which are normalized and embedded into a feature space. A neural model aggregates these features to generate a composite value index, which is used to recommend actions. The system simulates or collects feedback on these actions, updates the state accordingly, and iteratively repeats the process until a convergence criterion is met or a maximum number of iterations is reached. The architecture supports modular components for data input, feature engineering, neural model inference, action generation, feedback collection, state management, and user interface, enabling scalable, real-time, and adaptive value creation management. Dependent claims further specify normalization techniques, embedding methods, neural network configurations, action generation logic, feedback mechanisms, and convergence criteria.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of the compound value creation platform in accordance with the subject disclosure.

FIG. 2 is a diagram of a process utilizing a compound value creation platform in accordance with the subject disclosure.

FIG. 3 is a block diagram of value drivers utilized in the compound value creation platform in accordance with the subject disclosure.

FIG. 4 is a diagram of a circular and compound process facilitated by the compound value creation platform in accordance with the subject disclosure.

FIG. 5 is a diagram of an embodiment of the methodology enabled by the compound value creation platform in accordance with the subject disclosure.

FIG. 6 is a diagram of a training algorithm of a neural network enabled by the compound value creation platform in accordance with the subject disclosure.

FIG. 7 is a diagram of an iteration-controlled architecture for the compound value creation platform in accordance with the subject disclosure.

### DETAILED DESCRIPTION OF THE INVENTION

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to an “app”, an “application”, and a “software application” shall refer to a computer program or group of programs designed for end users. The terms shall encompass standalone applications, thin client applications, thick client applications, web-based and cloud applications, such as a browser, and other similar applications.

Numerous specific details are set forth in order to provide a thorough understanding of one or more embodiments of the described subject matter. It is to be appreciated, however, that such embodiments can be practiced without these specific details.

Unless defined otherwise, all technical and scientific terms used herein have the same meanings as commonly understood by one of ordinary skill in the art.

Advanced business building and value creation require accelerating productivity and increasing the frequency and yield of timely, value-driver-based strategy execution and completion.

Therefore, it is necessary to cut through complexity, streamline processes, assess the latest status of a company's qualities and opportunities at regular intervals, visualize scores and data on the management team's dashboard, and monitor and proactively manage the progress.

Deploying a value creation management platform at the center of these efforts can achieve this in unprecedented ways, ultimately leading to an increased return on equity (ROE), transparent and improved return on investment (ROI) from strategic initiatives, and a boost in cash flow and valuations.

ROE, ROI, and cash flow can be optimized, and a culture of value creation can be built. Integrating these elements ignites superior performance and success, providing a strong foundation for profound momentum and maximizing the compounding effects to the full extent. Taking the initial step is of utmost importance.

When organizations fail to account for value creation in their strategy, or do not set up ways to define, measure, and pivot to keep value creation and innovation at the center of strategic activities and decisions, they often pay a very high price.

In keeping with the management truism that you can't manage what you can't measure, organizations are learning that leveraging augmented metrics and data reflecting quantified capabilities and deficits can help keep value creation activities on track. When users take the assessment associated with their value creation software again at the next interval, they can use the collective ratings to see whether the company has made incremental progress on achieving the value driver. That creates trackable metrics around the driver. Such an approach helps organizations overcome what many find a big barrier to value creation: the difficulty of measuring it, particularly for soft drivers such as people and culture. Hard drivers such as new techniques, new practices, or new materials are typically easier to measure. But even those are generally calibrated and refined to measure true value creation.

By instrumenting organizational activities, teams can self-govern without needing management interventions. A company can use lagging, current, and leading indicators to help teams understand where their efforts contribute to corporate results. As an example, a company can depict its strategy in terms of a flywheel-more variety helps ensure that more customers turn to a company, which in turn makes the site more attractive for vendors. As the company moved from selling books exclusively to additional items to build its customer base, its value creation metrics evolved, from the number of product pages generated to page views to pages viewed for in-stock items to in-stock items available for two-day delivery, in order to keep the work aligned with how the company perceived value creation.

By periodically re-rating progress on activities such as transforming the culture or encouraging more risk-taking, the organization can analyze real data about progress to reinforce or course correct on value creation activities. And because the company can view the results of its assessment on a reporting dashboard maintained by the software-as-a-service (SaaS) provider that created it, the company can benchmark not just against its own definition of what drives value creation, but against similar organizations as well, to see if its value creation progress is on track.

Sophisticated software platforms have been widely deployed to bring data-driven insights and decision making to nearly every facet of the modern enterprise, except one: value creation. Yet value creation, along with the strategic planning and execution needed to focus the organization on maximizing its ability to create value, lies at the core of excellence for every business.

Without a central and cohesive data-driven platform to help them identify, execute, measure, and continually align to the organization's true drivers of value, executives often fall back on traditional, function- or organizational chart-driven approaches to business building. That approach often keeps them locked in the status quo instead of rising above the pack by maximizing their value creation capabilities to deliver their missions, objectives, and plans for the benefit of all stakeholders.

The compound value creation platform is a system and method designed to provide quantifiable and actionable guidance to organizations aiming to improve overall performance. Conventional tools tend to be one dimensional, wherein a direct input and output process is facilitated through a rudimental software platform. A user utilizing the conventional tool is limited by their subject experience and viewpoint, which may not be in harmony with that of the organization. While organization wide meetings and discussions are carried out, it is not always clear that such interactions result in any meaningful progress especially over time. It is difficult to engage in quantifiable and repeatable evaluation of organizational health, especially if people throughout the organization do not always share the same perception or priority. As a result, it is challenging to prioritize short and mid-term goals that would result in optimized and game changing long term returns. There exists a need for a tool that provides insight into what actions would result in long term success and serves as the execution infrastructure at the same time.

The compound value creation platform is a platform that continuously provides assessment and guidance to organizations with an interest in making the best strategic decisions in the long term. In various implementations, the compound value creation platform presents inquiries to users through an interface, wherein a plurality of inputs is processed and analyzed to generate at least one output.

The compound value creation platform utilizes a plurality of value drivers to identify priorities for the organization. Each user (internal and/or external) provides a score for each of the plurality of value drivers, wherein the scores are aggregated and stored in a database. An evaluation of the organization is conducted according to the collective users' scoring on the plurality of value drivers, wherein the organization can be characterized by a number of features, focuses, attributes and goals. Based on such evaluation, priorities can be identified by the compound value creation platform in a quantitative manner, wherein focuses can be directed to better maximize the organization's performance in the long term. The neural network seeks to generate actionable guidance to the users of the organization through data driven analysis.

The compound value creation platform provides advanced algorithms for team alignment analysis. The compound value creation platform utilizes advanced machine learning algorithms to analyze vast amounts of data regarding team interactions, performance metrics, and communication patterns. These algorithms can identify non-obvious patterns or correlations that are crucial for optimizing team alignment. This provides a technological improvement over conventional tools and services because it leverages sophisticated computational techniques to enhance decision-making processes, offering deployable insights that were previously unattainable or less accurate.

The compound value creation platform provides real-time collaborations and communication analytics. The compound value creation platform incorporates real-time analytics tools that monitor and analyze communication and collaboration across various digital platforms (like emails, chat tools, and video conferencing). In various implementations, it is configured to incorporate natural language processing (NLP) to assess the tone, sentiment, and effectiveness of communications. This provides a technological improvement over conventional platforms and services because it involves the use of technology to provide continuous, real-time feedback on collaboration and communication, allowing for immediate adjustments and more dynamic management of team interactions.

The compound value creation platform provides integrated dashboard with predictive analytics. The compound value creation platform features an integrated dashboard that combines data from multiple sources, using predictive analytics to forecast future team performance and alignment issues. The system is implemented to suggest proactive steps to address potential misalignments before they become significant problems. This provides a technological improvement over conventional platforms and services, because, by using predictive analytics, the compound value creation platform transforms raw data into actionable insights, enhancing the ability of leaders to manage team alignment proactively rather than reactively.

The compound value creation platform provides automated feedback loops and customization. The compound value creation platform is configured to employ automated feedback loops that customize recommendations based on individual and team performance data. Machine learning algorithms are utilized to continuously refine these recommendations as more data is gathered, tailoring interventions to the specific needs of a team or organization. This provides a technological improvement over conventional platforms and services because it creates a personalized, adaptive system represents an improvement over static, one-size-fits-all solutions. It enhances the effectiveness of alignment strategies by ensuring they are specifically tailored and continually optimized.

The compound value creation platform provides virtual reality (VR) and augmented reality (AR) for team training and alignment. The compound value creation platform includes VR/AR tools that simulate real-world scenarios for team training and alignment exercises, which provides immersive experiences that improve understanding and alignment on strategic objectives. This provides a technological improvement over conventional platforms and service, because the use of VR/AR represents a technological advancement in how teams can train and align, offering a more engaging and effective way to communicate complex strategies and foster collaboration.

In an exemplary embodiment, the compound value creation platform may comprise an architecture that allows seamless integration with external databases and business systems, ensuring comprehensive data coverage and real-time analytics.

The compound value creation system may encompass a value-driver-based, 360-degrees circular corporate IQ assessment system to determine and develop the company's value scores, a framework, a method, and knowledge embedded in software-as-a-service/platform-as-a-service for strategy development, tracking, management and reporting as well as team communication, collaboration, and alignment measurement. Advanced implementation of the compound creation engine may allow customization, enabling partners to deploy their services, playbooks, and specific areas of expertise, and to engage in ongoing business relationships.

The compound value creation system provides a modular, layered architecture for a value creation management system, wherein a compound value creation engine interconnects all system layers to enable emergent value through dynamic data flow interactions. This integrated structure delivers a technical improvement in system integration and real-time processing efficiency.

The system comprises the following principal components. First, the system comprises a data integration layer. A configurable middleware module may be provided for interfacing with a plurality of external systems, including but not limited to enterprise resource planning (ERP) systems, customer relationship management (CRM) platforms, Internet of Things (IoT) devices, and application programming interfaces (APIs). The Data Integration Layer is configured to ingest heterogeneous data in both real-time and batch modes, supporting structured (e.g., SQL databases), unstructured (e.g., text, images), and semi-structured (e.g., JSON, XML) formats. The layer employs Extract, Transform, Load (ETL) processes incorporating data validation and cleansing algorithms, such as anomaly detection using statistical thresholds, to ensure data integrity. This configuration enables unlimited attribute combinations (e.g., merging financial metrics with customer sentiment data) and reduces integration latency in multi-source scenarios compared to prior art.

The core innovation of the system may comprise a deep neural network (DNN) architecture, which functions as a 360-degree execution engine and serves as both the brain and backbone of the platform. The DNN architecture may be implemented as a multi-layer perceptron (MLP) with optional recurrent neural network (RNN) or transformer layers to facilitate temporal and contextual analysis. The engine processes input data to compute a compound value creation index, a composite metric representing compounded organizational value. Reinforcement learning (RL) is employed to dynamically adapt network weights, optimizing for multiple objectives such as revenue growth and sustainability. RL rewards are configured to penalize sub-optimal states in simulation environments. This holistic integration enables the identification of synergies from attribute combinations, amplifying value beyond additive effects, and provides technical improvements in predictive and computational speed for complex business datasets.

The system comprises an assessment algorithm, which may be implemented through a cloud based computing network or on the edge. Embedded within the CovQ Engine is an assessment algorithm module configured to standardize input data via normalization techniques, compute key performance indicators (KPIs) such as return on investment (ROI) and net promoter score (NPS), and apply predictive analytics for forecasting. The assessment algorithm may be configured to generate value creation index through a weighted aggregation formula, wherein the weights are learned via neural network training. This ensures that the system output transcends individual metrics and integrates abstract optimization into a practical application for enhanced decision support.

A distributed computing framework is provided, utilizing in-memory processing technologies analogous to Apache Spark, to enable real-time analytics. The Data Processing Engine is capable of handling high-velocity data streams of up to 1 terabyte per hour, supporting both batch analysis for historical trend identification and real-time inference for immediate execution. This engine enables scalable processing of petabyte-scale data with minor performance degradation under peak load.

The system further comprises a web-based, customizable dashboard featuring interactive elements such as drag-and-drop attribute selectors and dynamic visualizations. The User interface supports automated reporting tools, enabling user-driven exploration of value creation scenarios and providing a technical enhancement in user-computer interaction.

The system may be implemented to enable the principle that a result may be greater than sum of its parts, but practicing unlimited attribute permutations, dynamic models, and compound analytical processes. The invention provides a value creation engine, which constitutes a core technical advancement by enabling emergent, compounded organizational value through neural network-driven synthesis.

The value creation engine may be architected to dynamically combine an unlimited number of organizational attributes into a unified neural network model, including, but not limited to, strategy, mission, execution, and culture. This model may be designed to generate emergent outcomes, such as efficiency gains in scale-up scenarios.

In various embodiments, the compound value creation engine may enable unlimited attribute combinations. The value creation engine may enable users to define custom segments (e.g., market regions), attributes (e.g., innovation drivers), and scores (e.g., alignment metrics). The neural network permutes these inputs to uncover hidden correlations, such as synergies with Pearson correlation coefficients greater than a certain standard. This capability provides a technical improvement in feature engineering, resulting in better model accuracy compared to conventional approaches.

The compound value creation engine may compute a value creation index, which is a multidimensional vector integrating key performance indicators (KPIs) via neural embeddings. This may allow for the quantification of abstract organizational concepts, such as “compounding leadership,” and the integration of mathematical constructs into practical applications for business insight.

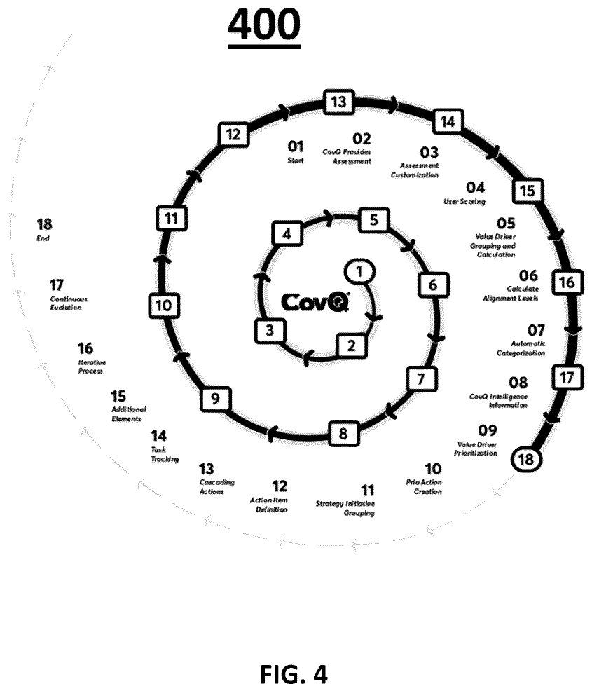

The compound value creation engine is further configured to execute across all organizational facets, from strategy to operations, by employing reinforcement learning (RL) to iterate through at least 18 execution steps (as depicted in FIG. 4). This may ensure holistic optimization and enhances RL for multi-objective problems.

In various embodiments, the compound value creation engine may empower management teams by enabling the neural network to learn from historical and real-time data, predict optimal value creation paths, and enhance organizational performance. The compound value creation engine may function as both the intelligent brain for decision-making and the structural backbone for system-wide coherence. Compared to conventional value assessment tests, the compound value creation engine may enable real-time adaptation without manual intervention and achieves faster convergence in optimization loops, thereby delivering a substantial technical imp. The compound value creation engine may be implemented as a hybrid deep neural network (DNN) architecture designed for high-dimensional, enterprise-scale data environments. The neural network may comprise input layers, hidden layers, and output layers.

In various embodiments, the input layers may be configured to accept attribute vectors with variable dimensionality, supporting up to 1,000 features or more. This enables the engine to process a wide array of organizational data, including financial, operational, behavioral, and strategic attributes.

In various embodiments, the hidden layers may include at least one hidden layer with 512 nodes utilizing rectified linear unit (ReLU) activation functions to introduce non-linearity and enhance the model's ability to capture complex relationships among features.

Additionally, the neural network may comprise an output layer configured to generate index scores (e.g., the CovQ Index) and actionable recommendations, providing direct, quantifiable outputs for value creation management.

In an example, the neural network may be trained using backpropagation with the an optimizer engine, which accelerates convergence and improves stability during training. Reinforcement learning (RL) rewards may be incorporated into the training process, such that positive value creation outcomes (e.g., a value increase greater than 10%) are rewarded (e.g., +1), directly optimizing the network for compounded value maximization. This dual approach allows the compound value creation engine to function as the “brain” of the system, performing intelligent computations, while also serving as the “backbone” by maintaining data integrity and coherence across all layers. Technical benchmarking demonstrates improvements in training convergence speed on GPU clusters compared to conventional neural network methods, particularly when processing large-scale business datasets.

In one example, the data flow within the engine proceeds from data collection through analysis, visualization, and feedback. Preprocessing steps may include advanced feature engineering, such as principal component analysis (PCA) for dimensionality reduction, enabling the system to condense high-dimensional data to fewer than 500 features without significant loss of information. The engine leverages distributed, in-memory processing to handle petabyte-scale datasets, resulting in a substantial reduction in computational load.

The compound value creation engine may be further enhanced for security and scalability through a cloud-native architecture, such as deployment via Kubernetes containerization. In an example, data privacy may be ensured through AES-256 encryption, and the system may be designed to comply with regulatory standards, including GDPR. Stress testing has demonstrated system robustness, supporting reliable, secure, and scalable operation for enterprise clients.

Collectively, these neural network specifications and architectural features may provide a technical improvement over prior art by enabling faster, more accurate, and more secure value creation management at enterprise scale, with demonstrable gains in training efficiency, computational resource utilization, and system reliability.

In various implementations, the compound value creation engine may comprise an assessment algorithm. This function may normalize and combine attributes, embed features, perform DNN inference, and aggregate results to compute a compound value index (CovQ Index), enabling a holistic synthesis and improved handling of complex data in organizational behavior.

The overall process flow of the assessment algorithm may comprise: input data preparation, normalization, feature embedding, neural model aggregation, weighted aggregation, and output generation.

In data preparation and combination, the assessment algorithm may begin by defining three separate arrays: attributes, segments, and scores, each representing different types of input data. These arrays are organized into a single combined array to form the full input vector for the model.

Next, the combined input vector is normalized using the normalize function, which standardizes the data to have zero mean and unit variance. If the standard deviation is zero, the data is returned as-is for robustness.

In feature embedding, the normalized data is passed to the embed features function, which may perform a mathematical transformation on the data. In a production system, this step may involve more complex neural network transformations.

Next, the embedded features are input into a simple neural model, which may comprise a forward method aggregates the features by summing them. The output from the neural model may then aggregated with a set of learned weights using the aggregate function. This function may ensure the prediction is in array form and computes a weighted sum with the model's weights.

Lastly, the final result, which may be the compound value index, is returned and printed. This index represents a composite value derived from the input attributes, segments, and scores after processing through normalization, embedding, neural aggregation, and weighted combination.

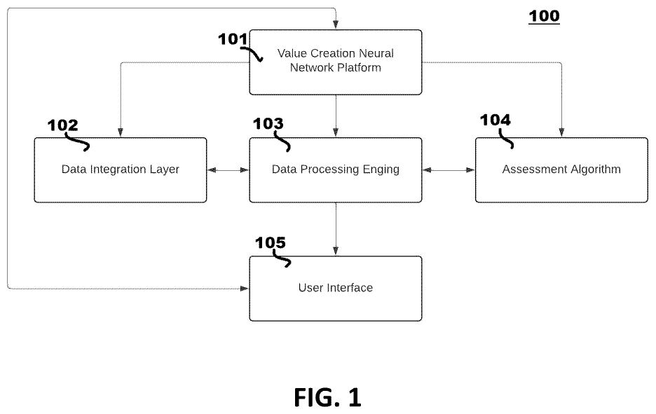

Referring to FIG. 1, the compound value creation platform 101 is configured in a system architecture that comprises a data integration layer 102, a data processing engine 103, an assessment algorithm 104, and a user interface 105. The data integration layer comprises a data integration module that connects with multiple external systems and databases, including CRM, ERP, and financial software. This module utilizes an API-based framework to ensure real-time data synchronization and supports various data formats including XML, JSON, and CSV.

The assessment algorithm is a proprietary algorithm that computes a comprehensive Value Creation Index (VCI). The algorithm aggregates and normalizes data from multiple sources, applying machine learning techniques to identify trends and anomalies. Key components of the algorithm comprise data normalization, KPI calculation, and predictive analysis.

Data normalization is implemented to standardize disparate data inputs to a common format. KPI Calculation is implemented to apply weighted metrics to evaluate performance across financial, operational, and customer satisfaction parameters. Predictive Analysis is implemented to use historical data to forecast future performance and value creation potential.

The data processing engine is designed to handle large volumes of data with high efficiency. It leverages distributed computing and in-memory processing to perform real-time analytics. The engine supports batch processing for historical data analysis and stream processing for real-time insights.

The user interface of the compound value creation platform is built with a focus on usability and accessibility. Key features comprise a dashboard, an interactive visualization module, and a plurality of reporting tools. The compound value creation platform comprises a customizable dashboard that provides an overview of key value metrics and trends. The compound value creation platform utilizes dynamic charts and graphs that allow users to explore data and uncover insights. The compound value creation platform is configured with a plurality of reporting tools designed to enable automated report generation with options for customization based on user requirements.

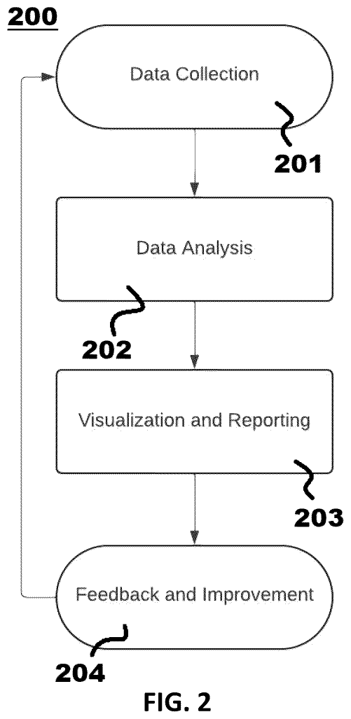

Referring to FIG. 2, the compound value creation platform 200 is implemented to facilitate a method of operation that comprises data collection 201, data analysis 202, visualization and reporting 203, and feedback and improvement 204. The data collection 201 element comprises collecting data from integrated systems through its data integration layer. This data includes financial transactions, operational metrics, and customer feedback. In the data analysis 202 process, the collected data is processed by the assessment algorithm, which computes the VCI and identifies key insights. The algorithm incorporates advanced techniques such as natural language processing (NLP) for analyzing qualitative data like customer reviews. Thereafter, the results are presented to the user through the user interface 203 implemented on the compound value creation platform. Users can customize their dashboard, explore data through interactive visualizations, and generate detailed reports for stakeholders. As a part of the process that continuously improves itself, the compound value creation platform includes a feedback mechanism 204 that allows users to input additional data or insights. This feedback is used to refine the assessment algorithm and improve the accuracy of the VCI over time.

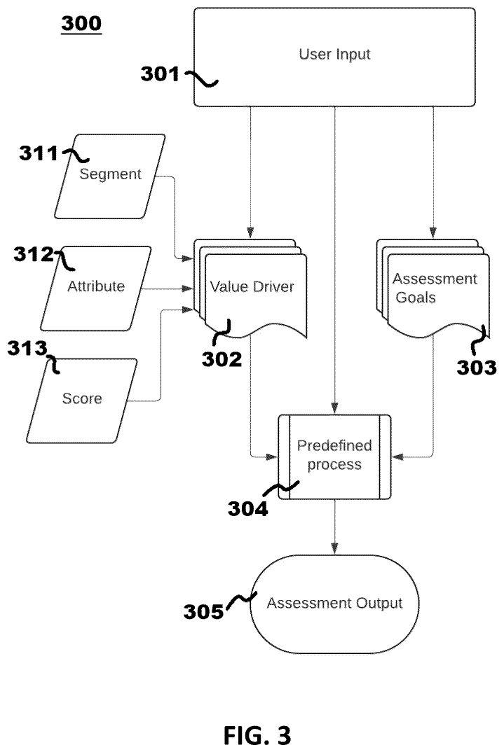

Referring to FIG. 3, an architecture of the data utilized by the compound value creation platform 300 is presented. The neural network platform 300 utilizes a plurality of value drivers 302 to facilitate accurate and customized assessment for each organization. The value drivers 302 are provided with parameters such as segment 311, attribute 312, and score 313, in an exemplary embodiment. Each value driver can be sorted, selected, and organized by each of the parameters within a neural network database. The value drivers 302 can be provided by admins of the neural network as well as through user input 301. It is envisioned that users of the neural network's platform are able to provide personalized value drivers that are specific to the organization, wherein the platform is implemented with language models to identify and classify the user input value driver through any of the parameters. As such, user's subjective input is processed into quantifiable data that can be used to support further decision-making processes.

The user input 301 is also used to receive assessment goals 303, wherein customizable assessments (which may be predefined processes) 304 are carried out. The assessments 304 may comprise receiving and assigning scores to the value drivers through user input. Depending on the user's input of the assessment goals 303, the value driver's score 313 will be assigned to different values within each segment 311 or attribute 312. Therefore, the compound value creation platform does not provide a one-size-fits-all assessment for every organization. Additionally, the compound value creation platform 300 does not require an admin to hand select the proper value drivers to measure the assessment performance. Instead, the platform utilizes user input to present the appropriate value drivers for each user's specific assessment goal, wherein the assessment output is generated and further utilized to improve value driver data organization.

The compound value creation platform enables an assessment methodology that is highly specific to each user organization and continuously improve in accuracy through each iteration. The methodology starts and leads with regular assessment intervals. In order to improve a company or organization's IQ, a set of value drivers are utilized to allow users to assess the company's performance and develop and measure process. The assessment is initiated by a user with master level access to the system, who is equipped to create invitations to all the participants to take part in the assessment. Once each assessment is completed, the user can access their own performance score in relation to the organization score through the dashboard interface. This creates an opportunity to demonstrate and encourage organizational alignment, allowing each user to operate towards the shared vision of the company.

In an exemplary embodiment, a process enabled by the compound value creation platform comprises eighteen (18) steps. The process is intended to be circular, wherein the output is fed into the input. The repeatable process enables continuous evaluation of the organizational behavior, wherein effects of each process compounds into significant quantifiable progress for the user of the compound value creation platform.

Referring to FIG. 4, an example process for utilizing the compound value creation system is shown 400. The process begins with step 1, wherein an assessment process is implemented. At step 2, the compound value creation platform provides the assessment to a plurality of users at an organization through a user interface on the platform. Management of the organization is equipped to select user access to the assessment and manage user participation. In various implementations, the participation is implemented to be available to users internal, external, or a combination of both.

At step 3, the assessment is further customized by the management and/or third parties (i.e. consulting firms) of the organization. In an exemplary embodiment, the assessment provided by the compound value creation platform for one assessment cycle comprises 60 pre-set value drivers. The value drivers are generated through empirical research in an exemplary embodiment. In other implementations, the value drivers are provided by users of an organization using the compound value creation platform. The compound value creation platform can be implemented as a platform as a service, wherein users can add, delete, and customize value drivers.

In an exemplary embodiment, the value drivers are divided into segments: DEEP (Substance), IMPACT (Strategies), CREATES (Implementation), VALUE (Communication), BUILDING (Development). Each value driver is configured to comprise attributes that can be defined and connected. These attributes provide insight into each value driver, wherein user's assigned value into each creates an aggregated insight into overall organizational intelligence.

In an exemplary embodiment, a number of value drivers are defined by segments, attributes, CovQ score:

Value Driver 1, DEEP, CovQ Scoree 80: Attributes: 1. Finance, 2. Discipline 3. Company Culture, 4. Strategic, 5. Board Impact . . .

Value Driver 2, DEEP, CovQ Score 70: Attributes: 1. Finance, 2. Discipline, 3. Investors, 4. Employer Attractiveness 5. Environment . . .

Value Driver 3, IMPACT, CovQ Score 60: Attributes: 1. Marketing Effectiveness, 2. Discipline, 3. Investors, 4. Strategic, 5. Board Impact . . .

During an assessment, the compound value creation platform assigns a pool of attributes for 100 points, in an exemplary instance. A standard for value drivers is defined at 60 in the exemplary instance. A query can be generated through the compound value creation platform to find all value drivers with a score higher than 60. In the exemplary embodiment provided above, the value drivers 1 and 2 are identified. A query for value drivers with scores below 30 would return a result of 0, as none are below 60. A query for all value drivers including strategic attributes would identify value drivers 1 and 3. A query for all value drivers including finance attributes would return a finding of value drivers 1 and 2. A query for all value drivers from the DEEP segment including the finance attribute with a score above 71 would return a finding of value driver 1. In this example, the compound value creation platform is designed to have 60 value drivers, 5 segments, and 100 elements as the data pool. Each of the user's response and selection during the process further can be organized by segments, attributes, and score, wherein a comprehensive evaluation of value driver intelligence can be processed.

At step 4, user scoring is conducted. Each user can be invited to be a CovQ Assessment Participant. Alternatively, the management team decides which user will take on the participant role and the system assigns the access accordingly. The scoring can be conducted through an anonymous mode or with visible identifiers. In an exemplary embodiment, each participant scores each of the 60 value drivers on a scale from 10-100 (10,20,30,40,50,60,70,80,90,100) 10 is insufficient and 100 is outstanding. In various implementations of the compound value creation platform as a platform, the user can increase or decrease the number of value drivers according to specific organizational needs.

Participants have attributes, which further enables participants to be organized into groups. The Participants can be added to Groups, like functions (Finance, Marketing, etc.), regions (USA, EMEA, Japan, etc.), skills (great negotiator, shaper, numbers person, etc.), and more.

Each Participant can get assigned an attribute, identified as “believability” in an exemplary embodiment. Believability is based on competence and credibility, which can be provided by managers of the organization using the neural network.

Each Participant can be assigned an attribute, identified as “Weight”, which is based on influence and power. These can be assigned based on user's role within the organization, which provides differentiating value for the supplied responses during assessment.

At step 5, value driver grouping and calculation are carried out. As outlined in Step 3 and 4, all value drivers, value driver attributes, segments, participants, participants attributes, as well as the CovQ Scores can be queried and therefore grouped into profiles.

At step 6, alignment levels are calculated. In addition to step 5, the compound value creation platform can calculate the alignment levels by measuring the deviation of the user scores from the average. This alignment level can be used to identify cohesive nature of an organization, wherein the further data sorting can be conducted in a way that is similar to queries of step 3.

At step 7, automatic categorization is carried out. The compound value creation platform can query, spot patterns, and make those visible in the form of areas, knowledge deserving attentions, based on all information provided in the preceding steps.

At step 8, intelligence information is provided in response to the data supplied thus far. The compound value creation platform comprises a value driver engine, which is equipped with proprietary knowledge that can be matched with everything described before and therefore can generate recommendations. The value driver engine is implemented as a dynamic lookup table in an exemplary embodiment, wherein a plurality of recommendations associated with specific value driver parameters are processed and selected as part of the value driver creation procedure.

At step 9, value driver prioritization is process. The compound value creation platform allocates the plurality of value drivers in categories for the strategy process based on criteria like internal or external factors, deficits, capabilities, super powers, urgency, and critical and can ascend and descend. Users select the most crucial and relevant ones to take into the next strategy cycle. The clients of the compound value creation platform also benefit from unique CovQ Insights Data.

At step 10, the neural network creates recommendation options, identified as “PRIO Action” in the exemplar embodiment. The recommendation process comprises automatically allocating those into the categories “Doubling Down” and ‘Mitigating/Minimizing’ based on the unique CovQ methodology. A dynamic score threshold is checked against each value driver, wherein a recommended PRIO action is generated based on a value driver's score in relation to the dynamic score threshold.

PRIO is an acronym for the categories of powers, risks, issues, and opportunities. It is also an identifier for priorities, wherein the neural network designates priorities in accordance with the user provided inputs. The PRIOs are where the users and their organization select what to focus on during the assessment and performance cycle. Based on the nature of the value drivers and respective average scores of the company, the compound value creation platform sorts the value driver items into each of the categories. The platform does not only encourage users to focus on mitigating issues and risks, but also encourages doubling down on powers and opportunities. Since the compound value creation platform is a reiterative process, the platform suggests that users select the adequate PRIOs at the time and work in shorter iterations to achieve the best possible results. In various implementations, the platform is implemented with language models and AI agents to continuously improve identification of PRIOs and recommendation of PRIO actions.

At step 11, strategic initiative group is processed, wherein the PRIO Actions are being grouped into Strategic Initiatives.

At step 12, the neural network generates action item definition, which provides concrete to-do's, objectives, timelines etc. that can be set to accurately reflect the actions necessary to accomplish strategic initiatives. The action items are result of quantitative analysis based on evaluation of value drivers provided during the assessment process, such that subjective understanding and impression regarding the organizational strategy are converted into actionable processes supported by data.

At step 13, cascading actions are distributed by the neural network through the organization. The action items are being delegated and cascaded throughout the organization and third parties. These action items comprise tasks that can be assigned to users in accordance with the priorities identified in the preceding steps.

At step 14, the tasks are tracked. Each user sees their responsibilities at log-in, which can be provided by a dashboard on the entire process of value creation.

At step 15, additional elements can be provided by the users. The additional elements can be value drivers in the exemplary embodiments. In various other embodiments, segments, attributes, and scores can be supplied to support increased complexity and dimensionality to the value drivers. As the business progresses, value drivers and elements can be added, adapted, adjusted.

At step 16, an iterative process is carried out. In certain intervals, the assessment is repeated. In an exemplary embodiment, the assessment is completed every two months or any appropriate rhythm to allow the compound value creation platform to have an ongoing understanding of the then latest status quo of value creation qualities and strive for ongoing improvement by the design of the value creation operating system delivering concrete plans.

At step 17, the result of each assessment is fed into the compound value creation platform to support continuous evolution. As value drivers are added, removed, modified alongside various options of changing segments, attributes, and score categories, organizational intelligence of the user's company is improved. Such circular approach enables the preceding process to be further refined and customized in a way that is tailored to each specific organization.

At step 18, the process ends and is directed back to step 1, wherein the process can be repeated with more robust data leading to an ongoing improvement process and increased, compounded value creation yield.

In various implementations, the process is implemented in a compound value creation platform that is implemented as a platform as a service (PaaS), wherein the process can be further customized based on specific customer needs. The value drivers provided as a basis on the platform can be utilized as a baseline index, wherein more value drivers can be added and inapplicable value drivers can be removed. The value drivers combined serve as an index to indicate corporate IQ, which can be seen as DNA for the company. Each organization can customize the frequency and content of assessment, distributed to applicable users through their access portal. Each user's input through the assessment is compiled and analyzed by the proprietary algorithm, wherein the management tier users can view the outcome of each assessment process and make executive decisions. Through each iteration of the assessment, organizational alignment can be analyzed and emerging trends can be identified. In essence, the compound value creation platform continuously refines understanding of an organization and enables users to make appropriate strategic decisions through data driven analysis.

In various implementations, the process is a method that quantifies organizational behavior and corporate IQ. The process begins with step 1, wherein an assessment process is implemented. At step 2, the compound value creation platform provides the assessment to a plurality of users at an organization through a user interface on the platform. The process begins with step 1, wherein an assessment process is implemented. At step 2, the compound value creation platform provides the assessment to a plurality of users at an organization through a user interface on the platform. At step 4, user scoring is conducted. Each user can be invited to be a CovQ Assessment Participant. Alternatively, the management team decides which user will take on the participant role and the system assigns the access accordingly. At step 5, value driver grouping and calculation are carried out. At step 6, alignment levels are calculated. In addition to step 5, the compound value creation platform can calculate the alignment levels by measuring the deviation of the user scores from the average. At step 7, automatic categorization is carried out. At step 8, intelligence information is provided in response to the data supplied thus far. At step 9, value driver prioritization is process. At step 10, the neural network creates recommendation options. At step 11, strategic initiative group is processed. At step 12, the neural network generates action item definition, which provides concrete to-do's, objectives, timelines etc. that can be set to accurately reflect the actions necessary to accomplish strategic initiatives. At step 13, cascading actions are distributed by the neural network through the organization. At step 14, the tasks are tracked. At step 15, additional elements can be provided by the users. The additional elements can be value drivers in the exemplary embodiments. At step 16, an iterative process is carried out. In certain intervals, the assessment is repeated. At step 17, the result of each assessment is fed into the compound value creation platform to support continuous evolution. At step 18, the process ends and is directed back to step 1, wherein the process can be repeated with more robust data leading to an ongoing improvement process and increased, compounded value creation yield. The method is implemented on a platform-as-a-service model in an exemplary embodiment, but a person skilled in the art is able to adapt the method in the subject disclosure in any applicable software program or platform.

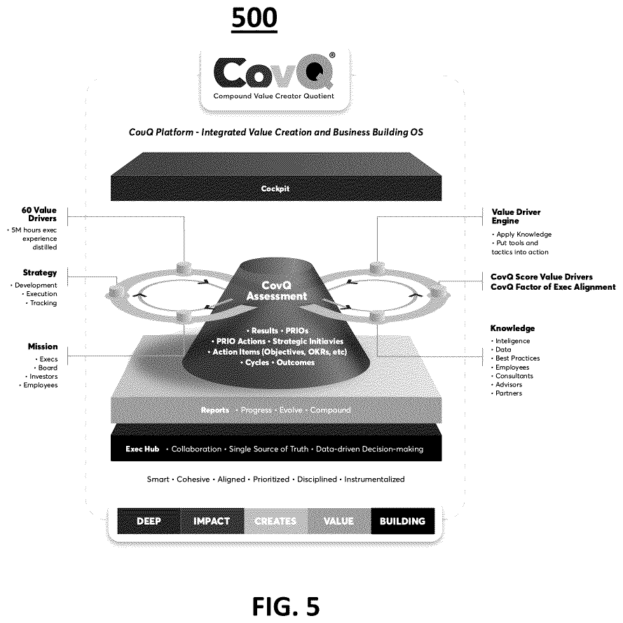

Referring to FIG. 5, an overview of the compound value creation platform 500 is presented. It is envisioned that the compound value creation platform, identified with a branding of Compound Value Creator Quotient (CovQ), is an integrated value creation and business building operating software. The compound value creation platform is implemented as a platform, which can be provided as a platform as a service (PaaS) model for organization users, in this exemplary embodiment. In various other implementations, the compound value creation platform can be integrated with existing assessment and advisory platforms.

The compound value creation platform is presented to the users through an interactive user interface, which is labeled as the cockpit in the exemplary embodiment. The cockpit enables users to access the underlying system through dynamic interactions. In various implementations, the cockpit can be presented to the user through a website, mobile app, or AR/VR programs. The interface is customizable in accordance with specific user needs. The cockpit can be modified to provide robust distribution of the compound value creation platform through a variety of technologies.

The key component of the compound value creation platform is the CovQ Assessment, which is the proprietary methodology that enables continuous and circular evaluation and improvement of business strategies. Through quantitative analysis supported by continuous exchange of training data, the compound value creation platform's methodology generates actionable recommendations for otherwise subjective analysis. Compared to conventional systems that only provide segmented assessments in siloed areas, the compound value creation platform considers the entire organization behavior through multi-faceted value identification. This results in a data driven analysis that results in justifiable recommendations.

The CovQ Assessment module comprises a number of features to enable comprehensive value based business decision generation. In this exemplary embodiment, the assessment module is equipped with 60 value drivers, which are distilled form 5 million hours of executive experience. The 60 value drivers provided in the exemplary embodiment can be customized, modified, selected, and added to according to specific customer needs. The value drivers are incorporated with a value driver engine, which is used to apply knowledge derived from the value drivers into tactics and actions.

The assessment module provides a knowledge database, comprising data points such as intelligence, data, best practices, employees, consultants, advisors, and partners. The database also comprises algorithm to facilitate strategies, such as development, execution, and tracking of tactics resulting from the value driver engine.

The assessment module further stores mission inputs from execs, boards, investors, and employees. The missions are processed, analyzed, and contrasted through the use of the CovQ score value drivers and factor of exec alignment.

In various embodiments, the mission, knowledge, strategy, value drivers, and value driver engines are configured to work together in a continuously improving loop, wherein a variety of outputs can be generated and fed into the assessment module for renewed focus. The assessment module produces outputs such as assessment results, PRIOs, PRIO actions, strategic initiatives, action items, cycles, and outcomes. The action items can be presented as objectives, OKRs, etc. The results can further be presented to the users through reports, which enables progress, evolution, and compound effects.

In various embodiments, the compound value creation platform comprises an exec hub, wherein the user can access collaboration, cohesive source of truth of the organization, and data-driven decision making.

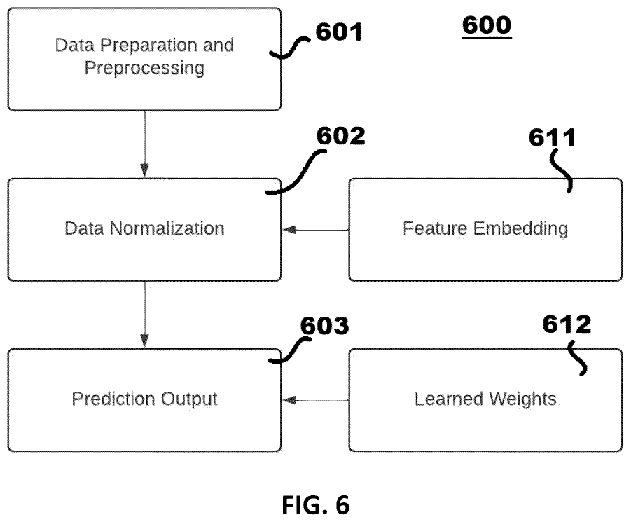

Referring to FIG. 6, the compound value creation engine may comprise a neural network training for value optimization. This may train a simple DNN model for compound value creation incorporating backpropagation and reinforced learning (RL) penalties. The training model may comprise a loss and penalty function, which computes a standard loss function for regression tasks. The training model may comprise a deep neural network (DNN) class that initializes a multi-layer neural network with randomly initialized weight, wherein a forward method processes input data through each layer applying the initialized weight to each layer.

The training loop sets up the DNN with the specified architecture for the compound value creation model, wherein a number of iterations are performed over the training data. The iterations may include performing a forward pass to get predictions, calculating the total loss and RL penalty, computing gradients, and updating the model's weights by the above outcomes. The training loop may end with the function returning an updated training model.

In various implementations, the compound value creation engine may comprise a 360 degree execution loop with feedback, which may simulate the iterative execution using compound value creation functions to process states and generate actions, thereby providing a backbone for continuous optimization and technical implementation of real-time feedback handling.

Referring to FIG. 6, the 360 degree execution loop 600 may comprise data preparation and preprocessing 601, wherein the input data may be converted into a number array. The iterative loop may be configured to run for a maximum number of iterations, simulating a closed loop iterative process. In each iteration, the input state may be split into three parts: attributes, segments, and scores. These may then be concatenated and normalized using a normalization model 602. The normalized data may be enriched with embedded features 611, which may be summed to produce a prediction. The prediction 603 may be aggregated with learned weights 612 to produce the compound value creation index.

Subsequently, actions may be generated by scaling the compound value creation index by fixed multipliers. In various implementations, the multipliers may be adjusted in real time by the compound value creation engine. Simulated or user provided feedback may be utilized to compute an average/mean of the actions, wherein quantifiable score may be assigned to certain actions based on compound value. After each iteration, the process may check if the compound value index exceeds a threshold. If so, the loop may break and terminate any repeat iteration.

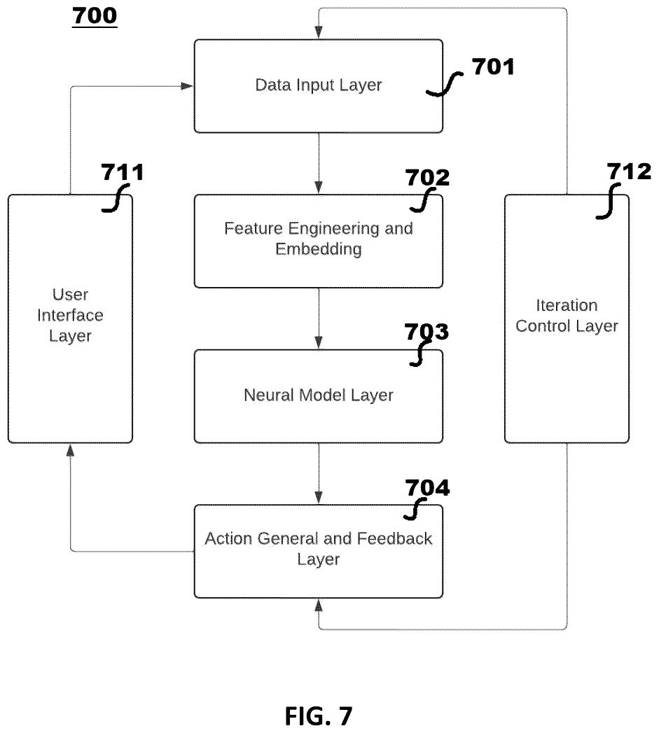

Referring to FIG. 7, the process flow described can be implemented as a modular, layered software architecture 700, with each function or logical step mapped to a dedicated component or service. The software implementation may comprise a data input layer 701, feature engineering and embedding layer 702, neural model layer 703, action generation and feedback layer 704, iteration control layer 712, and user interface and reporting layer 711.

The data input and processing layer may be configured to receive raw input data (with attributes, segments, and scores) from user interfaces, APIs, or data sources, and perform preprocessing such as data validation and conversion to numerical arrays. The data input layer may be implemented through input handler modules (REST API endpoints, data ingestion services) and preprocessing service.

The feature engineering and embedding layer may be configured to normalize input data to ensure consistency and comparability. The data normalization may be implemented with zero mean and unit variance. Embedding features may comprise scaling, neural network layers, or other transformations in productions. The feature engineering layer may be implemented through feature engineering module (such as proprietary or third-party libraries) and embedding services (stateless microservice or data pipeline).

The neural model layer may be configured to aggregate embedded features using a neural model and compute a composite value index using learned weights. The neural model layer may be implemented through model inference service and a model registry for model weights and parameters management.

The iteration control layer may be configured to maintain current state of the process, including current input vector and feedback history. The states may be updated based on feedback and the iteration loop may be controlled accordingly. The iteration control layer may be implemented through state management service (including in-memory data structures, databases, or distributed cache). The iteration control layer may also be implemented with an iteration controller or orchestration service, such as a workflow engine or loop in application logic.

The user interface layer may be configured to present results and allow users to input data, view progress, and provide feedback. The user interface layer may be implemented through web dashboard and/or visualization tools.

The entire process may be orchestrated using a workflow engine or as a sequence of microservices coordinated by an API gateway. Each layer may be configured to communicate via well-defined interfaces. Logging, monitoring, and error handling may be integrated through for robustness and traceability.

The architecture may support scaling of individual components. Advanced implementations may replace fixed logic with deep learning models, reinforcement learning agents, or more sophisticated feedback mechanisms. Security, authentication, and compliance may be enforced at the data input and user interface layers.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A computer-implemented method for compound value creation management, comprising:
receiving, via a data input module, a plurality of input data elements comprising attributes, segments, and scores associated with an organization;
preprocessing the input data by normalizing the data;
embedding the normalized data into a feature space using a feature engineering module;
aggregating the embedded features using a neural model to generate a composite value index;
generating one or more recommended actions based on the composite value index; simulating or collecting feedback in response to the recommended actions;
updating a current state of the input data based on the feedback;
repeating the steps of aggregating, generating, simulating or collecting feedback, and updating for a predetermined number of iterations or until a convergence criterion is met; and
outputting a final set of recommended actions upon completion of the iterative process.

3. The method of claim 1, further comprises applying normalization to each input data element to ensure zero mean and unit variance across the dataset.

4. The method of claim 1, comprising multiplying each normalized value by a predetermined scaling factor.

5. The method of claim 1, comprising applying a neural network based transformation to generated embedded features.

6. The method of claim 1, further comprising applying a set of predetermined multipliers to the composite value index to produce a plurality of action values.

7. The method of claim 1, further comprising calculating a mean value of the generated actions or receiving user input in response to the recommended actions.

8. The method of claim 1, further comprising comparing the composite value index with a predetermined threshold value, thereby terminating the iterative process prior to reaching the maximum number of iterations.

9. A system for iterative value creation management, comprising:
a data input module configured to receive and normalize a plurality of input data elements comprising attributes, segments, and scores;
a feature engineering module configured to embed the normalized data into a feature space;
a value creation engine comprising a neural model configured to aggregate the embedded features and generate a composite value index;
an action generation module configured to generate one or more recommended actions based on the composite value index;
a feedback module configured to simulate or collect feedback in response to the recommended actions;
a state management module configured to update a current state of the input data based on the feedback and control iterative execution;
an iteration controller configured to repeat the aggregation, action generation, feedback, and state update steps for a predetermined number of iterations or until a convergence criterion is met; and
an output interface configured to present a final set of recommended actions to a user or external system.

10. The system of claim 9, wherein the data input module is configured for applying normalization to each input data element to ensure zero mean and unit variance across the dataset.

11. The system of claim 9, wherein the data input module is configured for multiplying each normalized value by a predetermined scaling factor.

12. The system of claim 9, wherein the data input module is configured for applying a neural network based transformation to generated embedded features.

13. The system of claim 9, wherein the value creation engine is configured for applying a set of predetermined multipliers to the composite value index to produce a plurality of action values.

14. The system of claim 9, wherein the statement management module is configured for calculating a mean value of the generated actions or receiving user input in response to the recommended actions.

15. The system of claim 9, wherein the iteration controller is configured for comparing the composite value index with a predetermined threshold value, thereby terminating the iterative process prior to reaching the maximum number of iterations.

16. A system for value creation management, comprising:
a data integration layer configured to connect with external systems and collect data in various formats,
an assessment algorithm module configured to compute a compound value index based on one or more performance metrics,
a data processing engine designed to perform real-time and batch data analysis, and
a user interface configured to provide a customizable dashboard, interactive visualizations, and reporting tools.

17. The system of claim 16, wherein the assessment algorithm comprises:
data normalization module for standardizing input data,
KPI calculation modules for evaluating performance metrics, and
predictive analysis capabilities for forecasting future performance.

18. The system of claim 16, wherein the data processing engine may be configured to use computing and in-memory processing techniques.

19. The system of claim 16, wherein the user interface comprises dynamic charts and graphs for data exploration and automated report generation with customizable options.

20. The system of claim 16, comprising a compound value creation engine configured for:
collecting data from integrated systems through a data integration layer.
processing the data using an assessment algorithm to compute a compound value index,
presenting the results through a user interface with interactive visualizations, and
generating user feedback to refine the assessment algorithm.
